(19) United States
(12) Patent Application Publication
(10) Pub. No.: US 2008/0011663 A1
(43) Pub. Date: Jan. 17, 2008

(54) Aquitransistors for Integrated Hydrologic Circuit

(76) Inventor: Kenneth J. Hsu, Surrey (GB)

Correspondence Address: BREINER & BREINER, L.L.C., P.O. BOX 320160, ALEXANDRIA, VA, 22320-0160, US

(21) Appl. No.: 11/629,218

(22) PCT Filed: Jun. 17, 2004
(86) PCT No.: PCT/CH04/00372

§ 371 Date: Jul. 5, 2007

(51) Int. Cl. C02F 1/00

(52) U.S. Cl. 210/291

(57) ABSTRACT

The aquitransistor includes a plurality of perforated pipes (1) embedded in a matrix (2, 3) of porous materials as well as suction pump means (4, 4′) installed at the outlet end of said performated pipes (1) to thereby increase the hydraulic gradient acting on the pipes.

### BACKGROUND OF THE INVENTION

The present invention relates to constructions enhancing or reducing the flow rate of fluid moving underground in order to achieve the practical purposes of underground combustion of organic-rich rocks, solution mining, enhanced oil recovery, rainwater harvesting and aquifer-recharge for water supplies and irrigation, flood control, groundwater hydroelectricity, groundwater pollution-control, etc.

The flow of fluid molecules or particles (water, oil, air, etc), in porous medium has been compared to the flow of electrons, and as a consequence the installations have been named hydrologic cells or integrated hydrologic circuits. The key to practical realization of such constructions are special devices to enhance the flow rates of fluids underground. The present invention teaches the category of devices, which could be placed underground to control the direction and rate of fluid flow in porous medium. Those devices have a function similar to the transistors in electronic industry, and therefore the invention that induces changes of flow-rate of ground water is called aquitransistor.

### DESCRIPTION OF PRIOR DEVELOPMENT

Groundwater constitutes 95% of water in Earth's crust, but current water supplies come largely from surface-water bodies: rivers, lakes, reservoirs behind dams, etc. Surface water is used because water flows in and out rapidly of surface reservoirs. Groundwater is less commonly exploited, not only because the rate of outflow is on the whole limited, too limited for example to be used for hydroelectricity-generation, but also because the slow inflow rate makes recharging of depleted aquifers difficult and costly.

Surface-water bodies are the most common form of constructions for rainwater harvesting and for aquifer-recharge. Reservoirs behind dams are most effective to collect the surface runoffs, which harvest rainfalls. The human and economic costs of making reservoir lakes behind high dams are such that fewer and fewer dams are built and planned today.

A current method of aquifer-recharge consists of water-seepage from an excavation, or of water pumped into wells drilled into the depleted aquifer. Those practices have limitation because of environmental and economic considerations.

This present invention teaches the basic plan of constructing aquitransistors and aquifilters as devices so that surface waters can be quickly filtered, stored, or recharged into depleted aquifers, or that ground waters can be quickly pumped out for urban and island water supplies, for irrigation, or for hydroelectricity generation.

### SUMMARY OF THE INVENTION

Aquitransistors as developed by the inventor consist of a conducting device embedded in a semi-conducting matrix. The conducting device commonly consists of perforated pipes of limited diameter. The semi-conducting matrix consists of layer or layers of gravels, sand, broken debris, and/or other coarse detritus with a large cross-sectional diameter perpendicular to the direction of flow.

Where perforated pipes are embedded in horizontally bedded sediments or debris, the rate of water flowing in or out of the pipes laterally (according to Bernoulli's Law) can be made equal to that of water flowing in and out of the semi-conducting matrix vertically, so that a steady-state of rapid movement of water in or out of underground can be achieved under a natural or artificially established hydrodynamic potential.

### SUMMARY OF THE INVENTION

The flow of groundwater according to the Darcy's Law states that the quantity of water Q flowing into or out of a porous medium is:
Q=K(ΔH/ΔL)A

The parameter K is transmissibility, (ΔH/ΔL) the hydraulic gradient, and A the cross sectional area perpendicular to the direction of flow.

Inventor's previous development of aquitransistors teaches the increase of water flow-rate through the increase of cross-sectional area A.

Experiments made with aquitransistors of practical size however have shown that the results obtained are in many cases still unsatisfactorily, obviously due to an insufficient hydraulic gradient.

It was therefore an object of the present invention to improve the construction of hitherto known aquitransistors in order to overcome the disadvantages determined and observed during experimental and practical work.

The solution of the problem has revealed to be surprisingly simple in that, in accordance with the essence of the present invention, suction pump means are to be installed at the outlet end of the perforated pipes forming part of the aquitransistor, in order to increase the flow rate through the aquitransistors by increasing the hydraulic gradient (ΔH/ΔL) of the flow through porous medium.

The invention will be described in more detail hereinafter.

Two types of aquitransistors can be constructed:

D-aquitransistor is a vertically placed aquitransistor of perforated pipe in a gravel matrix. It is protected from the intrusion of suspension by commercially available filter. The D-aquitransistor is used mainly for underground transport of water from a surface source.

S-aquitransistor is a horizontally placed aquitransistor of a row of pipes in a gravel matrix. To construct an S-aquitransistor, an area is excavated. Perforated pipes are embedded in horizontally bedded sediments or debris. The aquitransistor is protected by a filter and a protective mantle. Water seeping through the relatively impermeable filter down a large area is accelerated by the enhanced hydrodynamical potential when water is pumped out of the ends of perforated pipes of the aquitransistor. The aquitransistor design considers the permeability of the filter, the area of the cross-section perpendicular to the direction of flow, and the pumping rate. A steady state is to be achieved so that the rate of water flow through the filter and protective mantle is made equal to the rate of water flowing through pipes. The rate is designed to fulfil a required daily consumption.

The filter consists e.g. of a well sorted silt, and is separated from the underlying protective mantle by a wire mesh. The silt above the wire mesh can be removed by hydraulic pressure after a certain time interval when the pores of the filter are largely filled up. The wire mesh prevents the silt of the filter from seeping down into the pores of the sands of the protective mantle, and it also prevents the sands of the underlying mantle from being eroded when the silt of the filter is removed to permit the laying down of a new layer of silt as filter.

The protective mantle consists of layers of well sorted sands, and the sands are so chosen with a medium diameter that sand particles would not fall into the pore space of the sands of the underlying layer. The graded bedding of the sands in the protective mantle prevents the intrusion of silt particles derived from overlying filter to penetrate into and to fill up the interstitial space of the gravel in the aquitransistor.

The S-aquitransistor is used mainly for directly collecting surface water over a large area, or for filtering large quantities of water.

According to the invention, suction pump means are installed at the outlet end of the perforated pipes.

### BRIEF DESCRIPTION OF THE ILLUSTRATIONS

Embodiments of the invention are shown in the accompanying drawings in which:

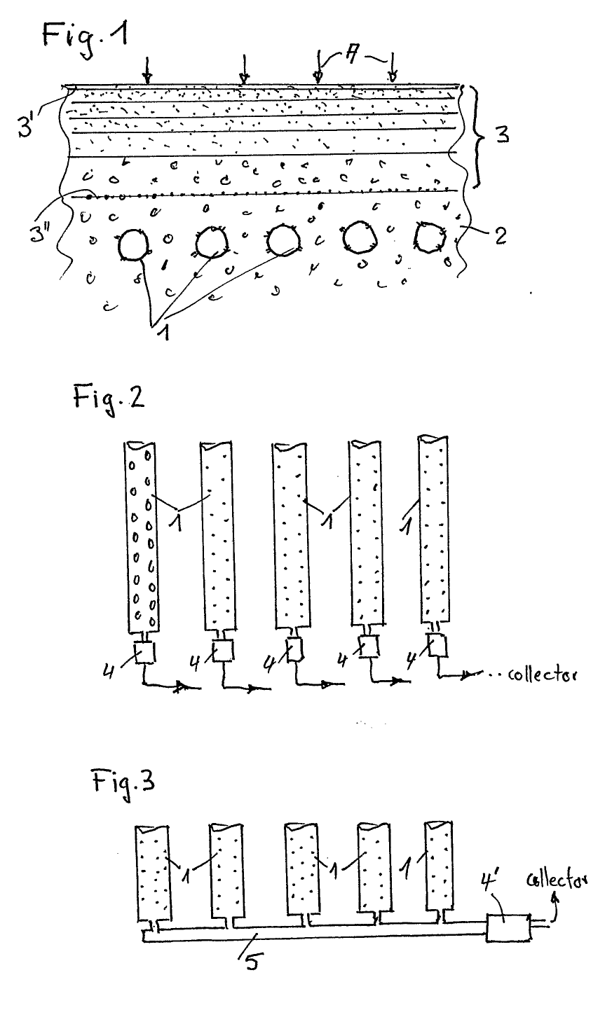

FIG. 1 shows schematically an aquitransistor in cross-section;

FIG. 2 shows an aquitransistor according to FIG. 1 equipped with the essential inventive features, namely suction pumping means at the outlet end of the perforated pipes of the aquitransistor, and

FIG. 3 an alternative embodiment of the construction shown in FIG. 2.

FIG. 1 of the drawings shows schematically an aquitransistor, comprising a multitude of perforated pipes 1 embedded in a semi-conducting matrix 2, 3 controlling the direction and rate of a fluid flow (schematically represented by the arrows A).

The matrix 2, 3 is formed by a semi-conducting medium presenting a large cross-sectional area perpendicularly to the direction of flow. The upper part 3 of the matrix forms an aquifilter, comprising stratified layers of differently sized sand, gravels or other debris permeable to water flow.

To repeat, aquitransistors consist of a conducting device embedded in a semi-conducting matrix. The conducting device commonly consists of perforated pipes of limited diameter. The semi-conducting matrix consists of layer or layers of gravels, sand, broken debris, and/or other coarse detritus with a large cross-sectional diameter perpendicular to the direction of flow.

Due to the perforated pipes 1 embedded in horizontally bedded sediments or debris 2, 3, the rate of water flowing in or out of the pipes laterally (according to Bernoulli's Law) can be made equal to that of water flowing in and out of the semi-conducting matrix vertically, so that a steady-state of rapid movement of water in or out of underground can be achieved under a natural or artificially established hydrodynamic potential.

As already stated, such a construction can not at all places or in all circumstances fulfil the desired requirements.

In order to improve the efficiency of the device, the invention proposes to increase the given hydraulic gradient (ΔH/ΔL) of the flow through the porous medium by installing suction pump means 4 at the outlet end of each perforated pipe 1. It is possible to provide an individual pump 4 for each pipe or to provide for a group of pipes 1 a kind of manifold which leads to a simple suction pump 4′ for such a group (see FIG. 3).

Reverting to FIG. 1 of the drawing, the aquitransistor shown is protected by a protective mantle consisting of two, three or more layers of well sorted sands or gravels 3 with the finest layer at the top. Overlying the protective mantle is the filter with well sorted coarse, medium, or fine silt 3′. The aquitransistor can be separated from the bottom layer of its protective mantle 3 by a wire mesh, and the top of the latter (20) from the filter (20) by another wire mesh 3″. The arrangement is made so to prevent the penetration of fine sedimentary particles into the interstitial space of the gravel in the aquitransistor.

1-6. (canceled)

7. An aquitransistor for use in integrated hydrologic circuits for filtering, collecting, storing and/or transporting water, comprising a plurality of perforated pipes embedded in a matrix of porous materials through which water flows due to hydrodynamic potential of the water before entering said pipes, wherein suction pump means are installed at an outlet end of said perforated pipes in order to increase the hydrodynamic potential of the water.

8. The aquitransistor according to claim 7, further comprising, overlaying or surrounding said aquitransistor, a protective mantle comprising layers of sorted sands, with the layers containing finer sands being in a higher part of said protective mantle and the layers containing coarse sands being in a lower part of the protective mantle to prevent fine sedimentary particles from entering the aquitransistor.

9. The aquitransistor as according to claim 8, wherein the mantle overlays or is surrounded by an aquifilter of sorted silt to prevent fine sedimentary particles from entering the protective mantle of the aquitransistor or the aquitransistor itself.

10. The aquitransistor according to claim 9, wherein the aquifilter is separated from the protective mantle by a wire mesh, so that said silt can be replaced through removal of old silt by hydraulic pressure and laying of new silt on top of the wire mesh to thereby prevent erosion of the sands of the protective mantle.

11. The aquitransistor according to claim 7, wherein the pump means comprise a suction pump installed at the outlet end of each one of said plurality of perforated pipes.

12. The aquitransistor according to claim 8, wherein the pump means comprise a suction pump installed at the outlet end of each one of said plurality of perforated pipes.

13. The aquitransistor according to claim 9, wherein the pump means comprise a suction pump installed at the outlet end of each one of said plurality of perforated pipes.

14. The aquitransistor according to claim 10, wherein the pump means comprise a suction pump installed at the outlet end of each one of said plurality of perforated pipes.

15. The aquitransistor according to claim 7, wherein the pump means comprise a manifold to which a group of said plurality of perforated pipes is connected and the manifold leads to a single suction pump for said group.

16. The aquitransistor according to claim 8, wherein the pump means comprise a manifold to which a group of said plurality of perforated pipes is connected and the manifold leads to a single suction pump for said group.

17. The aquitransistor according to claim 9, wherein the pump means comprise a manifold to which a group of said plurality of perforated pipes is connected and the manifold leads to a single suction pump for said group.

18. The aquitransistor according to claim 10, wherein the pump means comprise a manifold to which a group of said plurality of perforated pipes is connected and the manifold leads to a single suction pump for said group.

19. The aquitransistor according to claim 11, wherein the pump means comprise a manifold to which a group of said plurality of perforated pipes is connected and the manifold leads to a single suction pump for said group.
